(19) United States
(12) Patent Application Publication
(10) Pub. No.: US 2025/0245577 A1
(43) Pub. Date: Jul. 31, 2025

(54) SYSTEM AND METHOD FOR GENERATING TRAINING DATA FOR FINE TUNING A MODEL IN A DATA SCARCE SETTING

(71) Applicant: Walmart Apollo, LLC, Bentonville, AR (US)

(72) Inventors: Ashkan Esmaeili, Santa Clara, CA (US); Yushang Lai, Sunnyvale, CA (US); Arpit Sharma, Suisun City, CA (US); Komal Arvind Dhuri, Milpitas, CA (US)

(21) Appl. No.: 19/030,087

(22) Filed: Jan. 17, 2025

Related U.S. Application Data
(60) Provisional application No. 63/627,290, filed on Jan. 31, 2024.

(51) Int. Cl. G06N 20/20

(52) U.S. Cl. CPC G06N 20/20

(57) ABSTRACT

System and methods for generating training data for fine tuning a model in a data scarce setting are disclosed. In some embodiments, a disclosed method includes: receiving, from a user interface, an indication of a customer's interaction with a website, the indication including a customer query, generating, using a first model, a plurality of synthetic queries, generating, using the first model, a plurality of synthetic responses to each of the plurality of synthetic queries, the plurality of synthetic responses being generated based on one or more rules and each synthetic response of the plurality of responses having a positive response and a negative response, aggregating, using a second model, the plurality of responses to generate training data, and training a third model using the training data, the third model configured to generate a response to the customer query in real-time.

### CROSS-REFERENCE TO RELATED APPLICATION

This application claims benefit to U.S. Provisional Application Ser. No. 63/627,290, entitled “SYSTEM AND METHOD FOR GENERATING TRAINING DATA FOR FINE TUNING A MODEL IN A DATA SCARCE SETTING,” filed on Jan. 31, 2024, the disclosure of which is incorporated herein by reference in its entirety.

### TECHNICAL FIELD

This application relates generally to generating training data and, more particularly, to systems and methods for generating training data for fine tuning a model in a data scarce settings.

### BACKGROUND

Artificial intelligence (AI) chats and assistants have become prevalent in dealing with companies and retailers. For example, a retailer may implement an AI chat function to allow customers to ask questions or receive information. Companies and retailers have to train the AI bots and also make sure that the AI bots are regulated and do not run afoul of certain codes of conducts.

Current methods of regulating AI bots and chat functions require large amounts of data to ensure that the AI bot and/or chat function is capable of generating the correct response. Some methods of regulating AI bots require human feedback to reinforce the models used by the AI bots.

### SUMMARY

The embodiments described herein are directed to systems and methods for generating training data for fine tuning a model in a data scarce setting.

In various embodiments, a system including a computing device comprising at least one processor in communication with the database, the computing device being configured to receive, from a user interface, an indication of a customer's interaction with the website, the indication including a customer query, generate, using a first model, a plurality of synthetic queries, generate, using the first model, a plurality of synthetic responses to each of the plurality of synthetic queries, the plurality of synthetic responses being generated based on one or more rules and each synthetic response of the plurality of responses having a positive response and a negative response, aggregate, using a second model, the plurality of responses to generate training data, and train a third model using the training data, the third model configured to generate a response to the customer query in real-time.

In various embodiments, a computer-implemented method is disclosed. The computer-implemented method includes receiving, from a user interface, an indication of a customer's interaction with the website, the indication including a customer query, generating, using a first model, a plurality of synthetic queries, generating, using the first model, a plurality of synthetic responses to each of the plurality of synthetic queries, the plurality of synthetic responses being generated based on one or more rules and each synthetic response of the plurality of responses having a positive response and a negative response, aggregating, using a second model, the plurality of responses to generate training data, and training a third model using the training data, the third model configured to generate a response to the customer query in real-time.

In various embodiments, a non-transitory computer readable medium having instructions stored thereon is disclosed. The instructions, when executed by at least one processor, cause at least one device to perform operations including: receiving, from a user interface, an indication of a customer's interaction with the website, the indication including a customer query, generating, using a first model, a plurality of synthetic queries, generating, using the first model, a plurality of synthetic responses to each of the plurality of synthetic queries, the plurality of synthetic responses being generated based on one or more rules and each synthetic response of the plurality of responses having a positive response and a negative response, aggregating, using a second model, the plurality of responses to generate training data, and training a third model using the training data, the third model configured to generate a response to the customer query in real-time.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to generate training data for fine tuning a model in a data scarce setting, in accordance with some embodiments of the present teaching.

FIG. 2 is a block diagram of a fine tuning system, in accordance with some embodiments of the present teaching.

FIG. 3 is a flow diagram of a system for generating training data for fine tuning a model in a data scarce setting, in accordance with some embodiments of the present teaching.

FIG. 4 is an illustration of fine tuning responses generated by the system of FIG. 3, in accordance with some embodiments of the present teaching.

FIG. 5 is a flowchart illustrating an exemplary method for generating training data for fine tuning a model in a data scarce setting, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for generating training data for fine tuning a model in a data scarce setting. In some embodiments, the systems and methods utilize one or more models (e.g., machine learning models) to generate training data for fine tuning a model in a data scarce setting. For example, the systems and method provided herein may generate synthetic queries, generate responses to the synthetic queries to generate an initial cold-start training dataset. The training dataset may then be used to train a model with proper configuration to provide preferred answers when prompted. In some embodiments, the configuration incorporates various rules (e.g., constitutions). The rules may be based off of a code of conduct or regulations.

In some embodiments, systems and methods for generating training data for fine tuning a model in a data scarce setting utilizes a fine tuning system (e.g., fine tuning system or system 102). System 102 may be configured to fine tune a model when large amount of data are unavailable. In some embodiments, the model is a generative AI model, such as a large language model (LLM). In some embodiments, system 102 uses one or more models to generate data to assist in training other models. For example, system 102 may generate a first training dataset for training a first model (e.g., a generation model). The first model may generate a second training dataset for training a second model (e.g., a preference model). The second model may be configured to generate training data for a third model (e.g., an SFT model). The second model may generate training data due to training data being scarce. In some embodiments, the systems and methods for generating training data for fine tuning a model in a data scarce setting utilizes a plurality of models. The plurality of models may be different models (e.g., a first model, a second model, and a third model).

One goal of the present teaching is to fine tune a preference model to generate an SFT model based on generation of data. In some embodiments, the present teaching is directed to generating data for training a preference model in a data scarce setting or environment. The preference model may be used to generate feedback (e.g., answers) to questions or queries received from a customer. In some embodiments, the preference model is configured to abide by constitutions (e.g., a code of conduct) to prevent the preference model from providing inappropriate information or information that runs afoul of predetermined guidelines. For example, a retailer may utilize the preference model to provide information to customer when prompted. The preference model may be configured by constitution-based prompt engineering to not run afoul of specific guidelines implemented by the retailer, such as not disparaging the retailer, not preferring competitors over the retailer, or not providing information that would assist in committing a crime or harmful act. The preference model output data is used as reliable data to train an SFT model which is free of any configuration and resource consumption. The SFT model is a final self-contained response generator in real-time.

In some embodiments, one or more filtering and/or review processes may be implemented at various stages to identify and/or prevent generation of undesirable content by the large language models or any other model utilized by the disclosed system. For example, one or more filtering processes may be applied to identify, remove, and/or otherwise eliminate undesirable content such as inappropriate content, offensive images, restricted images, etc. Although specific embodiments are discussed herein, it will be appreciated that any suitable filtering may be applied at any suitable steps of the disclosed methods.

In some embodiments, the system includes a user interface to receive customer input and display responses from the SFT model. A customer may interact with the SFT model via the user interface and the responses from the SFT model may be displayed on the user interface. In some embodiments, system is configured to provide responses to the customer in real-time upon receipt of inputs or queries from the customer. Real-time may be under one second, under two seconds, under three seconds, or under five seconds. In some embodiments, generating a response in real-time includes generating a response upon receipt of an input without human intervention. This may require that the SFT model is independent of any configuration using constitution rules.

In some embodiments, the system and methods presented herein are configured to generate fine-tuning data for a model, such as a supervised learning AI model. In some embodiments, the system and methods presented herein utilize a first model (e.g., generation model), a second model (e.g., a preference model) and a third model (e.g., an SFT model). The generation model may be used to train a preference model to generate training data. The preference model may be trained to generate training data, which may be used to train the SFT model. Upon training the SFT model, the SFT model may be fine-tuned and may abide by guidelines (e.g., constitutions, code of conduct).

Furthermore, in the following, various embodiments are described with respect to methods and systems for generating training data for fine tuning a model in a data scarce setting utilizes a fine tuning system. In some embodiments, a disclosed method includes: receiving, from a user interface, an indication of a customer's interaction with the website, the indication including a customer query, generating, using a first model, a plurality of synthetic queries, generating, using the first model, a plurality of synthetic responses to each of the plurality of synthetic queries, the plurality of synthetic responses being generated based on one or more rules and each synthetic response of the plurality of responses having a positive response and a negative response, aggregating, using a second model, the plurality of responses to generate training data, and training a third model using the training data, the third model configured to generate a response to the customer query in real-time.

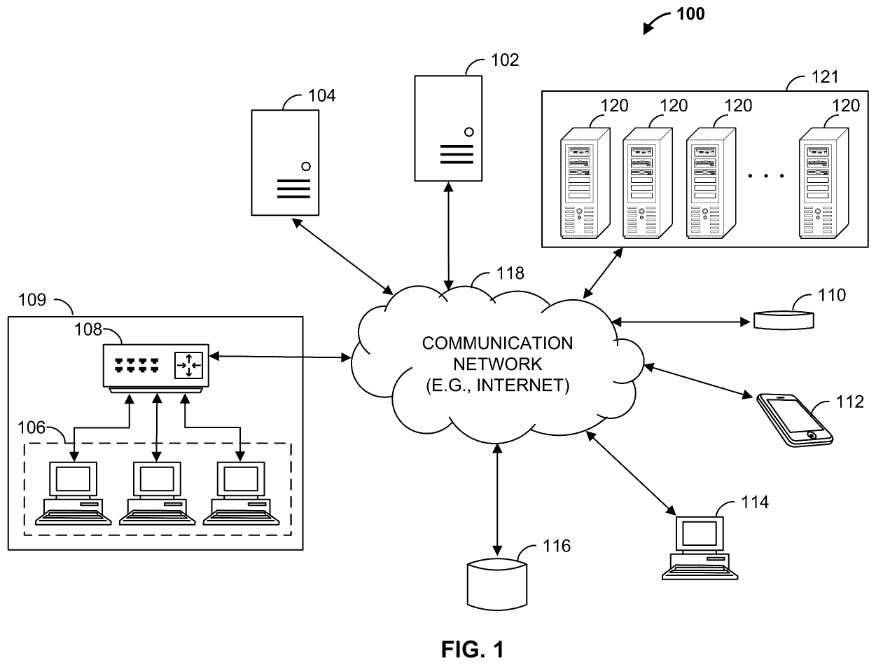

Turning to the drawings, FIG. 1 is a network environment 100 configured to generate cohesive product recommendations and variants, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, system 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The system 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the system 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the system 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the system 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the system 102 over the communication network 118. The workstation(s) 106 may send data to, and receive data from, the system 102. For example, the workstation(s) 106 may transmit guideline data (e.g., code of conduct or constitutions) to system 102.

Although FIG. 1 illustrates three user computing devices 110, 112, 114, the network environment 100 can include any number of user computing devices 110, 112, 114. Similarly, the network environment 100 can include any number of the system 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a chat function or AI presented through a website, such as a retailer's website hosted by the web server 104.

In some examples, a customer may operate one of the user computing devices 110, 112, 114 to initiate a web browser that is directed to the website hosted by the web server 104. The customer may, via the web browser, view a user interface for interacting with a chat function or AI bot provided by system 102.

In some examples, a user (e.g., a customer) may use one of the user computing devices 110, 112, 114 to view and interact act with a chat function or AI bot provided by system 102. For example, a customer may input queries into a chat function provided by system 102 (e.g., displayed via a user interface). The user may use a user interface to interact with the chat function via web server 104. The user may, via the web browser or the user interface, view and interact with one or more chat functions. The website may capture at least some of these activities as user data. The web server 104 may transmit the user data to the system 102 over the communication network 118, and/or store the user data to the database 116. In some embodiments, the user data is used for training one or more models associated with system 102.

In some examples, the system 102 may execute one or more models (e.g., algorithms), such as a generative AI models (e.g., LLM), mathematical models, machine learning model, deep learning model, statistical model, etc., to generate and implement markdowns for one or more products. The system 102 may utilize one or more models to provide a chat function to a customer. The chat function may be an AI chat function trained using one or more models.

The system 102 is further operable to communicate with the database 116 over the communication network 118. For example, the system 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the system 102, in some examples, the database 116 can be a local storage device, such as a hard drive, a non-volatile memory, or a USB stick. The system 102 may store historical data, business metrics, user data, or data associated with one or more customers interacting with a website via the web server 104 in the database 116. The system 102 may receive customer data (e.g., customer historical data). The system 102 may also receive from the web server 104 user session data identifying events associated with browsing sessions, and may store the user session data in the database 116. Database 116 may be coupled to a computing device. For example, database 116 may be coupled to one or more user computing devices 110, 112, 114 via communication network 118.

In some embodiments, the web server 104 transmits a model training request to the system 102. Upon the model training request, the system 102 may retrieve, e.g. from the database 116, historical data associated browsing history of a customer. The system 102 may train one or more models using the historical data of the customer. In some embodiments, the customer's interactions with the chat function (e.g., AI bot) provided by system 102 are stored as interaction data. The one or more models may be trained and/or refined using the interaction data. The one or more models may be trained to generate training data to be used with a subsequent model. The subsequent model may be used by the chat function to provide responses to customer queries. In some embodiments, the one or more models are configured to receive feedback from the customer to refine or retrain the one or more models. For example, a customer may interact with the chat function (e.g., AI bot) and receive a helpful or useful response. The customer may input, via a user interface, an indication that the response was beneficial. This indication may be inputted into the one or more models to refine the one or more models used by system 102.

In some embodiments, the outputs from the model may be used to refine and train the model. For example, one or more models may be trained using interaction data of the customer. System 102 may receive interaction data associated with the customer's interactions with a chat function (e.g., AI model or bot) provided by system 102. The purchase data, including the purchased products, may be inputted into the one or more models such that the one or more models compares the purchased products to the recommended products to generate a comparison value. The greater the comparison value the greater the deviation the purchased product is from the recommended products. In other words, the greater the comparison value, the less accurate the one or more models is. In some embodiments, the comparison value may be inputted into the one or more models to refine the one or more models to make the one or more models more accurate.

In some examples, the system 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units.

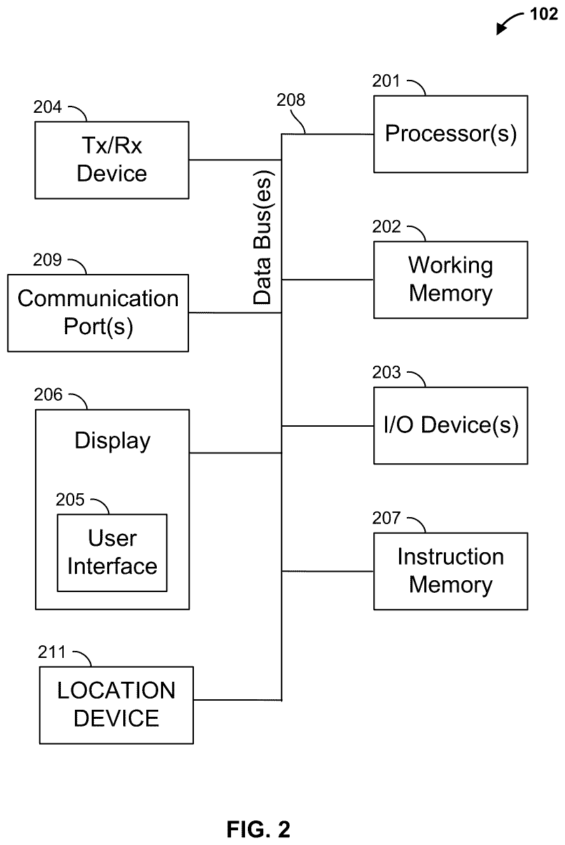

FIG. 2 illustrates a block diagram of a fine tuning system, e.g. system 102 of FIG. 1, in accordance with some embodiments of the present teaching. In some embodiments, each of the system 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the system 102 can be combined, omitted, and/or replicated. In addition, it will be appreciated that additional elements other than those illustrated in FIG. 2 can be added to the system 102.

As shown in FIG. 2, the system 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the system 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the system 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the system 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the system 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the system 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the system 102 and/or the web server 104. For example, the user interface 205 can be a user interface for an application of a network environment operator that allows a customer to interact with a chat function or AI bot provided by system 102. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the system 102 may determine a local geographical area (e.g., town, city, state, etc.) of its position.

In some embodiments, the system 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the system 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. In some embodiments, system 102 generates training data using one or more models. The training data may include interaction data and/or historical data of customers. Further, the training systems is configured to receive feedback information at least through the graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained models.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Responses generated by system 102 are compared to customer interactions (e.g., interaction data) to ensure that the set of models are operating with a certain threshold confidence. Further, the model training system is configured to receive feedback information through the graphical user interface corresponding to actions by the recipient interfacing with the graphical user interface.

The above and below description includes descriptions of embodiments implementing and/or utilizing trained machine learning models and/or neural networks. In some embodiments, the neural network, machine learning models and/or machine learning algorithms may include, but are not limited to, Large Language Models (LLM), Heuristics, Univariate based techniques, Multivariate, control limit, isolation forest and LOF—ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

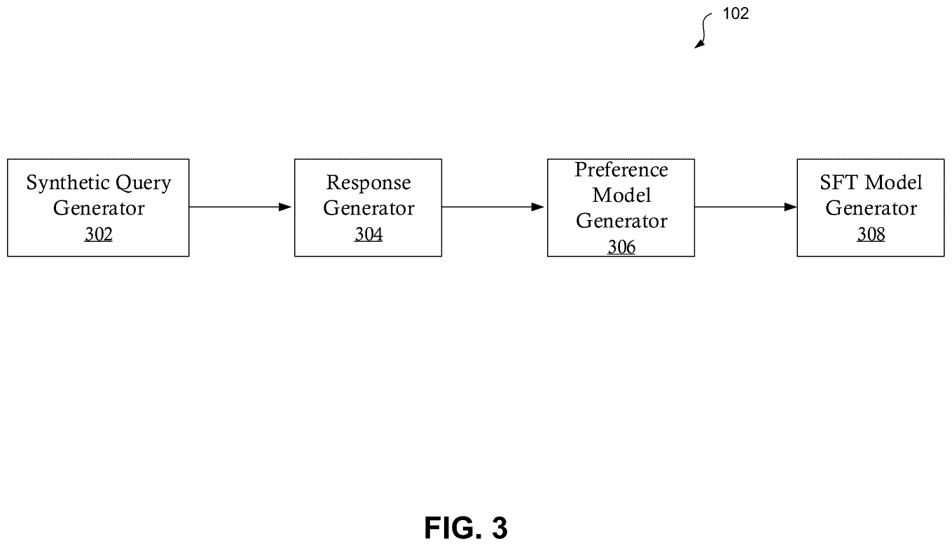

FIG. 3 is a flow diagram of system 102, in accordance with some embodiments of the present teaching. As indicated in FIG. 3, system 102 may include synthetic query generator or query generator 302, response generator 304, preference model generator 306, and SFT model generator 308. Using one or more models, system 102 may be configured to generate responses based on inputs from a customer. The responses may be generated to abide by guidelines, such as constitutions or code of conduct. The one or more models (e.g., generative AI models) used by system 102 may be required to be compliant with one or more guidelines. The guidelines may be stored within database 116 and retrieved by system 102 for training one or more models used by system 102. The guidelines may frame how the responses are generated by system 102 based on inputs from a customer. For example, the guidelines may require that the responses generated by system 102 cannot disparage or include any negative comments about a retailer. The guidelines may require that the responses generated by system 102 cannot refer to any competitors. In some embodiments, the guidelines require that the responses generated by system 102 use diplomatic language and convey information to the customer that is readily digestible. The guidelines may require that the responses generated by system 102 do not include any harmful language or provide information regarding harmful or illegal activity. In some embodiments, the guidelines (stored as guideline data within database 116) are inputted into system 102 by a user and/or are provided to system 102 via an external source. The one or more models provided by system 102 for a customer to interact with may be compliant with the guidelines.

In some embodiments, query generator 302 is configured to generate a set of synthetic queries. For example, query generator 302 may use a generation model (e.g., a generative AI model) to generate synthetic queries. The generation model may be a model different than the preference model and the SFT model. Query generator 302 may use one or more models (e.g., a generation model) to generate the set of synthetic queries from one or more customers and/or templates. Response generator 304 may generate responses to the set of synthetic queries generated by query generator 302. In some embodiments, response generator 304 uses one or more models (e.g., a generative AI model) to generate synthetic responses in response to each query of the set of synthetic queries based on prompting (e.g., written instructions) to one or more models, such as a generative AI model (e.g., LLM). For example, response generator 304 may utilize the generation model to generate responses. The generation model may be generative AI model. In some embodiments, the prompting is based on one or more rules (e.g., constitutions or guidelines). The prompting may result in generation of positive toned responses and negative toned responses to allow for diversity within the synthetic responses. In some embodiments, the generation of the synthetic responses allow for cold starting of the preference model.

In some embodiments, response generator 304 generates a positive response and a negative response for each query of the set of synthetic queries. Response generator 304 may use one or more models, such as the generation model, to generate responses for each query of the set of synthetic queries. Response generator 304 may judge the responses to get feedback on the responses and assign rating values to each response. In some embodiments, response generator 304 forms a training dataset for training the preference model based on the responses generated in response to the set of synthetic queries. Response generator 304 may generate positive responses and negative responses to allow for a spectrum of responses. The preference model may learn the spectrum to generate diverse data.

Preference model generator 306 may be configured to generate scalable data that abide by constitutions. The scalable data may be used to train an SFT model. Preference model generator 306 may be configured to train a preference model based on the queries and responses (e.g., training dataset). Upon training of the preference model, the preference model may be configured (e.g., undergo configuration) using the dataset generated by response generator 304. The preference model may be a configured trained model to address the problem of data scarcity and reliable data generation. Upon training the preference model, SFT model generator 308 is configured to generate fine-tuned training data using the preference model followed by training an SFT model. The data generated by the preference model may also be partially supervised to provide optimal responses based on customer inputs. SFT model generator 308 may use supervised fine-tuning on the trained preference model to generate an SFT model and ensure that the SFT model continues to perform as desired. The SFT model may be configured to be constantly evaluated and fine-tuned to ensure that is preforms as desired. The SFT model may be used by system 102 to provide responses to a customer or user's input or query. For example, system 102 may use SFT model within a chat function on a website to provide responses to a query from a customer interacting with the chat function on the website. The responses generated by the SFT model may abide by the guidelines.

Synthetic query generator or query generator 302 may be configured to generate synthetic data. In some embodiments, query generator 302 generates query templates for one or more categories (e.g., domains). Query generator 302 may generate templates for various domains associated with providing information to a customer interacting with a website of a retailer. For example, query generator 302 may generate domains for customer support, employee treatment, warranties, shipping, policies, HR related queries, general inquiries, or special cases.

Query generator 302 may be configured to generate synthetic query templates. The templates may include placeholders that can be replaced with products offered by the retailer. In some embodiments, the templates include placeholders corresponding to products, specific inputs, specific questions, one or more retailers. Query generator 302 may generate a plurality of synthetic queries by replacing the placeholders in each of the templates with a corresponding value (e.g., product, retailer, input, or question). For example, a query template may have a placeholder for a product (e.g., placeholder product) and query generator 302 may replace the placeholder product with a plurality of different products to generate a plurality of queries associated with a different products. By way of another example, a query template may have a placeholder for one or more retailers (e.g., placeholder retailer) and query generator 302 may replace the placeholder retailer with one or more retailers to generate a plurality of queries associated with one or more retailers. For each query template, query generator 302 may generate a plurality of synthetic queries.

In some embodiments, query generator 302 is configured to use one or more models (e.g., a generation model) to generate a plurality of additional synthetic queries. For example, query generator 302 may use a generative AI model to generate a plurality of additional synthetic queries based on the synthetic queries previously generated by query generator 302. In some embodiments, the additional synthetic queries are similar to the synthetic queries previously generated. The additional synthetic queries may be directed to pre-defined concepts (e.g., return policy, salaries, human resource topics). In some embodiments, the additional synthetic queries are related to the synthetic queries previously generated. For example, the additional synthetic queries may have a high temperature, which may be a parameter to control the randomness of the model (e.g., generative AI model) outputs. This results in the additional synthetic queries being at least tangentially related to the synthetic queries previously generated. Query generator 302 may combine the synthetic queries and the addition synthetic queries to form a set of synthetic queries. Query generator 302 may transmit the set of synthetic queries to response generator 304.

In some embodiments, response generator 304 receives the set of synthetic queries generated by query generator 302. Response generator 304 may be configured to generate responses to each query in the set of synthetic queries. Response generator 304 may be configured to apply one or more rules (e.g., constitutions, code of conduct) to the responses generated. Response generator 304 may utilize one or more models, such as an AI model (e.g., the generation model) utilized by query generator 302, to generate a plurality of synthetic responses in response to the set of synthetic queries. In some embodiments, the one or more models utilized by system 102 (e.g., the generation model, the preference model, and/or the SFT model) is a generative AI model such as a large language model (LLM).

In some embodiments, response generator 304 generates positive criteria associated with a positive response tone and negative criteria associated with a negative response tone for each rule. For example, system 102 may include a plurality of rules based on a code of conduct or constitutions. For each rule, response generator 304 may generate positive criteria and negative criteria. The positive criteria may abide by the rule and the negative criteria may be counter or fun afoul of the rule. For example, for a rule that states a response should not include any negative statement or information regarding a retailer, positive criteria may not include any negative statements or information regarding the retailer and negative criteria may include a negative statement or information regarding the retailer. In some embodiments, response generator 304 is configured to generate responses which will be used as training data for another model(s), such as the preference model.

Response generator 304 may generate, using one or more models, a response to each query of the set of synthetic queries using the positive and negative criteria for each rule. For example, for a single query, response generator 304 may generate a plurality of synthetic response each having a positive tone or a negative tone for each rule. In other words, for each query, response generator 304 may generate a plurality of synthetic responses for each rule and each response of the plurality of response may have a positive tone or a negative tone. In some embodiments, a synthetic response generated by response generator 304 in response to a query of the set of synthetic queries incorporates one or more rules.

In some embodiments, response generator 304 is configured to rate each generated synthetic response. For example, response generator 304 may apply a binary rating (e.g., 0 or 1) for each response where 0 is associated with a negative tone (e.g., neutral or running afoul of a rule) and 1 is associated with a positive tone (e.g., abiding by a rule). Response generator 304 may generate synthetic responses and then rate each rate based on the one or more rules to determine how much the response is line with the rules (e.g., constitutions or code of conduct).

In some embodiments, response generator 304 is configured to scale each response having a negative tone. For example, response generator 304, using one or more models (e.g., an AI based judge and/or the generation model), may determine that a response having a negative tone severely runs afoul of a rule and thus should be rated less than 0. Response generator 304 may scale responses having a negative tone based on how much they run afoul of one or more rules. Responses having a negative tone may initially have a rating of 0 and then may be scaled by response generator 304 resulting in a rating of −1, −2, −3, or less than −3. In some embodiments, each rule of the one or more rules is weighted such that one rule may have a higher weight than another rule. A response running afoul of a higher weighted rule (e.g., negative tone) may be scaled to have a lower rating than a response running afoul of a lower weighted rule. For example, a first rule may have a higher importance than a second rule and thus may be weighted greater than the second rule. A synthetic response generated by response generator that runs afoul of the first rule may have a lower scaled rating (e.g., rating of −8) than a synthetic response generated by response generator that runs afoul of the second rule (e.g., rating of −1). Response generator 304, for each query of the set of query, generates a positive response having a positive tone and a negative response having a negative tone, where each of the positive response and the negative response incorporates one or more rules.

In some embodiments, response generator 304 aggregates the scores of each rule for each response and generates a weighted score or weight rating for each response. An example is provided in Table 1 below.

TABLE 1

| Rating Score | Rule 1 | Rule 2 | Rule 3 | Rule 4 | Rule 5 |
|---|---|---|---|---|---|
| Positive | 1 | 1 | 1 | 1 | 1 |
| Negative | −1 | −2 | −3 | −1 | −1 |
| (Neutral) | | | | | |

As shown in Table 1, a response that follows rules 1, 2, 4, 5, but runs afoul of rule 3 may have a weighted score of 1. A response that follows rules 1, 2, 3, 4, 5 but runs afoul of rule 5 may have weighted score of 3.

In some embodiments, response generator 304 is configured to generate a pair of completion dataset (e.g., paired dataset). In some embodiments, each pair has two responses with different scores. For example, the pair of paired dataset may include the synthetic query, a positive response, and a negative response. the paired dataset may include each query of the set of synthetic queries generated by query generator 302 paired with its respective positive response and negative response generated by response generator 304. In some embodiments, the paired dataset is used for training of the preference model such that the first model is trained to develop a preference for a specific type of response, such as the positive response.

In some embodiments, the pair of paired dataset is generated according to set of dataset rules. The dataset rules may require that the positive response has a higher weighted rating/score than the negative response, the positive response has a weighted rating/score greater than 0, and implementing quantity criteria for responses. For example, the paired dataset may be generated to be a diverse and balanced dataset to ensure there are enough negative responses to compare to the positive response. The paired dataset may be used as a training dataset for preference model generator 306. For example, paired dataset may be used to train or refine one or more models (e.g., the preference model and/or the performance model) to learn which generated responses are positive and which are negative. In some embodiments, preference model is configured to provided responses that are similar to the positive response. For example, using the paired dataset as a training dataset for the preference model, the preference model may provide responses that are closer to the positive responses. The preference model generating responses that are closed to the positive responses may result in the generation of more data that can be used to fine tune one or more models, such as the SFT model.

Preference model generator 306 may be configured to train the preference model based on the training dataset (e.g., paired dataset) generated by response generator 304. In some embodiments, preference model generator 306 is configured to train a preference model using the training dataset generated by response generator 304. Upon training, the preference model may be configured to generate responses to queries that have a positive tone and do not run afoul of any of the rules. In some embodiments, the trained preference model utilizes sentence level loss and aims to generate response that align with one or more rules.

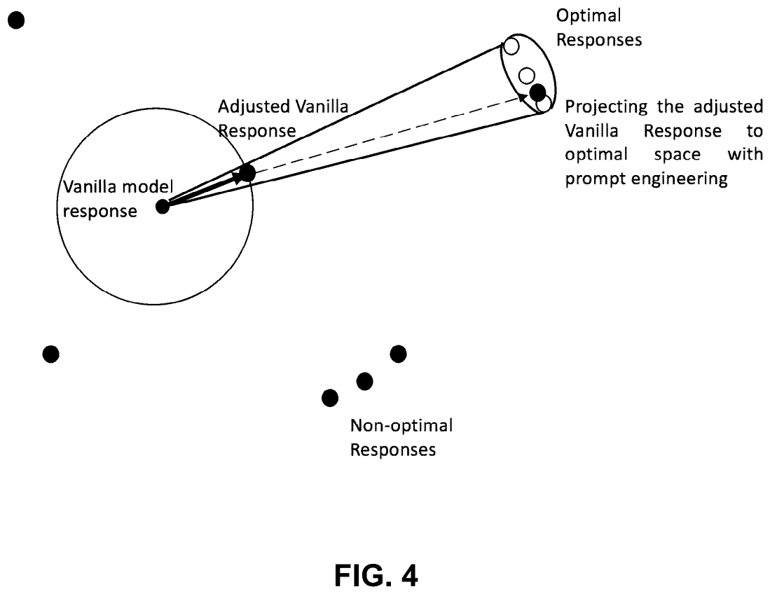

Upon generation of the paired dataset, the preference model may be trained, such as via Direct Policy Optimization (DPO). DPO training may be used to train a model to learn good information (e.g., positive responses) and unlearn bad information (e.g., negative responses). In some embodiments, up on DPO training, the preference model has a preference towards outputting positive responses and a divergence from negative responses. This is illustrated in FIG. 4. For example, FIG. 4 is an illustration of outputs of the preference model. As illustrated in FIG. 4, the preference model may be configured to output good responses. However, the preference model may not output optimal responses, but only good responses, and thus may need configuration, as discussed below.

With continued reference to FIG. 3, preference model generator 306 may be configured to train the preference model. Preference model generator 306 may use one or more rules and the positive responses to adjust the output of the preference model to the optimal responses. This is combination of DPO training of the preference model with prompt engineering (e.g., configuration) may be configured to yield optimal responses. Optimal responses may be responses that abide by one or more rules and sound more human-like than the good responses. Upon configuration of the preference model, the output of the preference model may be used to address the scarcity problem by generating a plethora of valid data. In some embodiments, this is used to scale out valid or desired answers (e.g., optimal answers).

The preference model may be trained by preference model generator 306 and the trained preference model may be used by SFT model generator 308 to generate and train an SFT model. The SFT model may be configuration free compared to the preference model, which requires configuration (e.g., prompting/prompt engineering). The SFT model may be configuration free since configuration (prompt engineering) consumes a lot of tokens (a token being ¾ of word). Using tokens in inference and in serving one or more models may result in undesired latency and require more resources. For example, the cost of using generative AI models, such as LLM, may be based on tokens. Further, the more tokens that are consumed in the input (prompt) to one or more models, such as the preference model and the SFT model, the higher the processing time since the tokens utilize and memory. The SFT model may be utilized by one or more customers of a retailer and thus it is more efficient and beneficial to train the SFT model to be configuration free. This also allows for the one or more rules to be scaled and easily changed/updated allowing for a stable and scalable solution.

In some embodiments, SFT model generator 308 is configured to generate and train an SFT model using supervised fine tuning (SFT). SFT may be used to directly learn the best and optimal responses. In some embodiments, the preference model is configured to generate data to be used by SFT model generator 308 to train the SFT model. In practice, reliable training data may be scarce and thus needs to be generated. Preference model generator 306 may be configured generate and train the preference model to output reliable training data that may be used by SFT model generator 308 to generate and train the SFT model. In some embodiments, SFT model generator 308 utilizes SFT to be configuration free thereby being more efficient and saving computing/processing power, memory, and other resources. For example, the SFT model may not need to be configured (e.g., using prompt engineering) compared to the preference model, which generated the training data, and allows for use by a retailer. The SFT model may be customer facing and thus may be used by many customers simultaneously. Therefore, the SFT model being configuration free and requiring less resources provides an advantage over conventional methods.

In some embodiments, the preference model is configured to generate data to address an issue with data scarcity and the SFT model generates responses to customer inputs in real-time. In some embodiments, the preference model is utilized in an offline mode, whereas the SFT model is customer facing and used in real-time to provide responses to customer inputs/prompts.

Referring to FIG. 4, in some embodiments, SFT is useful if there are ambient and high-quality data to change the next token probabilities of an LLM to the expected behavior. Preference model generator 306 may be configured to obtain and scale data for SFT for training of the SFT model. In some embodiments, preference model generator 306 is configured to utilize prompt engineering on the preference model to generate good responses and SFT model generator 308 may take the good responses and train the SFT model to generate optimal response. For example, the preference model may be configured to generate adjusted responses based on training using preference model generator 306 and the training dataset. The adjusted responses may be responses to a query that abide by one or more rules. SFT model generator 308 may be configured to use the responses generated by the preference model to train an SFT model to generate optimal responses.

In some embodiments, system 102 is configured to run an SFT process on a sampling of responses generated by the SFT model. System 102 may be configured to ensure that the SFT model is still performing as desired and still generating optimal responses. For example, the SFT model may receive a query from a customer via a website (e.g., chat function of a website) and the SFT model may be configured to generate a response. System 102 may apply SFT to the response to ensure the one or more rules are followed and that the response is the optimal response.

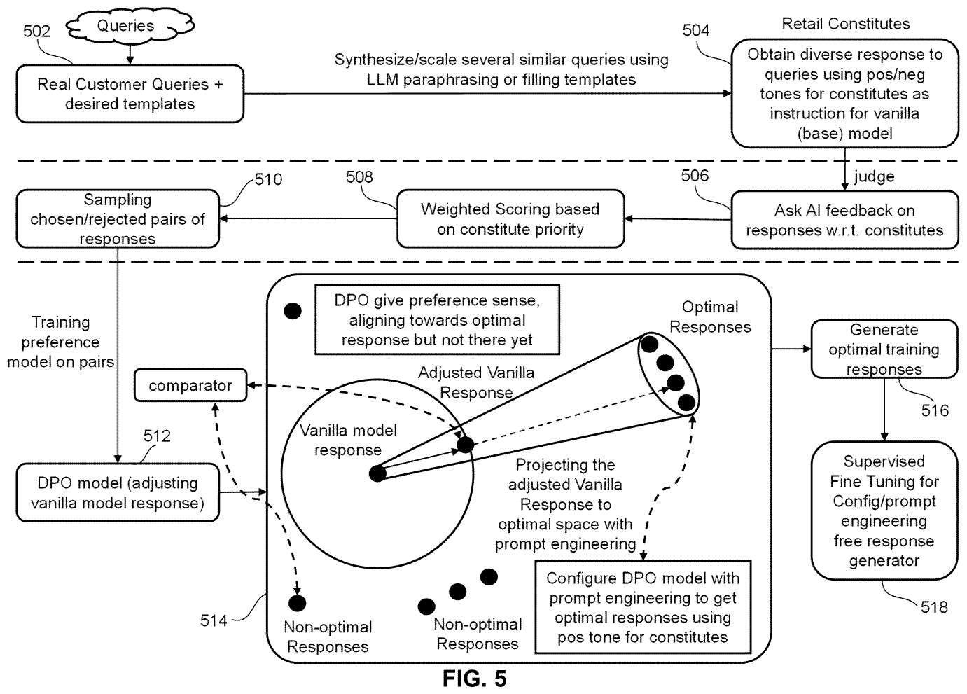

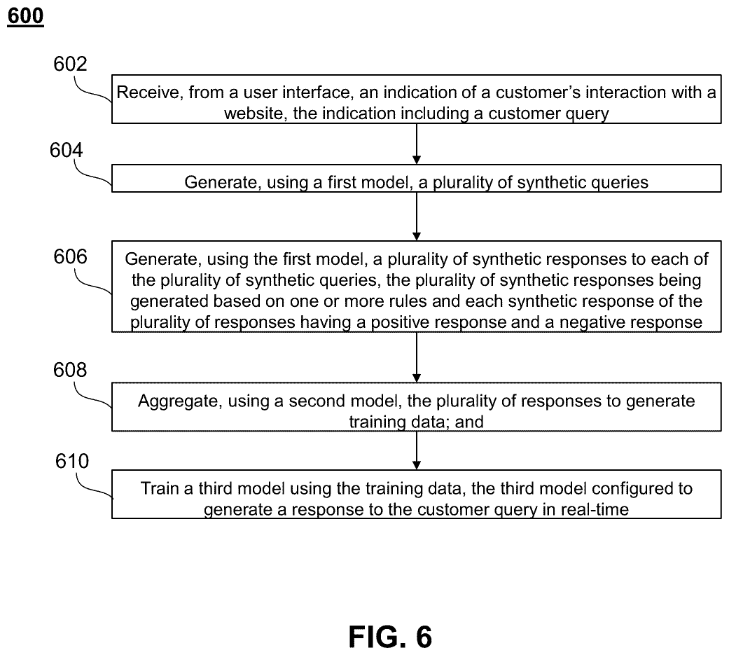

FIG. 5 is a flowchart illustrating an exemplary method of generating training data for fine tuning a model in a data scarce setting. At operation 502, system 102 may be configured to receive real customer queries and templates. System 102 may be configured to synthesize and/or scale a plurality of synthetic queries based on the real customer queries and/or templates. System 102 may use one or more models, such as generative AI model (e.g., LLM), to synthesize the plurality of synthetic queries. At operation 504, system 102 may be configured to generate diverse synthetic responses to the synthetic queries. The diverse responses may include positive responses having a positive tone and negative responses having a negative tone. The positive responses may be responses that abide by one or more rules and the negative responses may be responses that are neutral to or run afoul to one or more rules. At operation 506, system 102 may use one or more models (e.g., a generic AI model) to generate feedback on the synthetic responses with regard to the one or more rules.

At operation 508, system 102 may apply one or more weights to each synthetic response based on the one or more rules. At operation 510, system 102 generates a paired dataset including a positive response and a negative response for each query. At operation 512, the paired dataset may be used to train one or more models, such as the preference model. The preference model may be trained to have a preference towards positive responses. At operation 514, the preference model is trained to generate good responses (but are not optimal responses yet). The preference model may be configured with prompt engineering to get to optimal responses using positive responses and the one or more rules. At operation 516, preference model may generate optimal training responses based on prompt engineering. At operation 518, the training responses generated by the preference model may be used to train an SFT model that is utilized by a customer of a retailer. The SFT model may be trained using SFT (supervised fine-tuning) to be configuration free (e.g., prompt engineering free) to enable the SFT model to utilize less resources and tokens. The SFT model may be trained to generate optimal response (e.g., responses that abide by open or more rules, provide the desired information, and/or sound human-like). System 102 may train the SFT model to generate optimal responses in response to an input or query from a customer. The SFT model may output/generate optimal responses in real-time upon receiving an input or query from a customer. For example, a customer may access a chat function on a website hosted by a retailer. The chat function may utilize the SFT model to generate and provide/transmit optimal responses in response to the customer's query.

FIG. 6 is a flowchart illustrating an exemplary method for generating training data for fine tuning a model in a data scarce setting. At operation 602, system 102 receives an indication of a customer's interaction with a website. In some embodiments, system 102 receives an indication of the customer's interaction from a user interface. The interaction of the customer may be with an AI bot or chat function associated with the website. At operation 604, system 102 may generate, using a first model, such as the generation model, a plurality of synthetic queries. The synthetic queries may be based on templates. At operation 606, system 102 may be configured to generate, using the first model, a plurality of synthetic responses in response to the generated synthetic queries. The synthetic responses may be based on one or more rules. In some embodiments, system 102 generates a plurality of synthetic responses based on one or more rules and the responses may include a positive response and negative response. Each response may be associated with at least one rule of the one or more rules. In some embodiments, each rule is weighted and the synthetic responses are scaled. At operation 608, system 102 may aggregate, using a second model (e.g., preference model), the synthetic responses to generate training data for training a third model (e.g., SFT model). The training data may be used to train the second model to provide responses to a query where the responses abide by one or more rules. The second model may be configured to generate data for training a third model. At operation 610, system 102 may be configured to train a third model, such as a SFT model, using the training data. The trained model may be configured to generate a customer response to the customer query. The customer response may abide by one or more rules.

Although the methods described above are with reference to the illustrated flowcharts, it will be appreciated that many other ways of performing the acts associated with the methods can be used. For example, the order of some operations may be changed, and some of the operations described may be optional.

In some embodiments, one or more filtering and/or review processes may be implemented at various stages to identify and/or prevent generation of undesirable image or response content. For example, one or more filtering processes may be applied to identify, remove, and/or otherwise eliminate undesirable content such as inappropriate images, offensive images, restricted images, etc. Filtering may occur at any suitable stage of an image generation process, such as, for example, one or more of step 602, 604, 606, 608, 610, etc. Although specific embodiments are discussed herein, it will be appreciated that any suitable filtering may applied at any suitable steps of the disclosed methods.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
generate, using a first model, a plurality of synthetic queries;
generate, using the first model, a plurality of synthetic responses to each of the plurality of synthetic queries, the plurality of synthetic responses being generated based on one or more rules;
aggregate, using a second model, the plurality of synthetic responses to generate a training dataset; and
train a third model using the training dataset, the third model configured to generate responses to user queries in real-time.

2. The system of claim 1, wherein:
each of the first model, the second model and the third model is at least one of: a machine learning model, a neural network, a large language model, or a generative artificial intelligence (AI) model.

3. The system of claim 1, wherein the plurality of synthetic queries are generated based on:
generating query templates for one or more domains associated with information provided to customers interacting with a website of a retailer, the query templates including placeholders related to the retailer;
replacing each placeholder in each of the query templates with a corresponding value to generate a first set of synthetic queries;
generating, based on the first set of synthetic queries, a second set of synthetic queries each directed to a pre-defined concept related to the retailer; and
combining the first set of synthetic queries and the second set of synthetic queries to form the plurality of synthetic queries.

4. The system of claim 1, wherein the plurality of synthetic responses to each synthetic query are generated based on:
generating the plurality of synthetic responses to the synthetic query based on the one or more rules, wherein:
the one or more rules include a plurality of rules,
for each rule of the plurality of rules, the plurality of synthetic responses include:
a positive response having a positive tone and generated based on a positive criteria regarding the rule, and
a negative response having a negative tone and generated based on a negative criteria regarding the rule;
generating a rating score regarding a corresponding rule for each synthetic response of the plurality of synthetic responses, by:
when the synthetic response is a positive response regarding the corresponding rule, generating a first rating as the rating score for the positive response,
when the synthetic response is a negative response regarding the corresponding rule,
generating a second rating different from the first rating,
scaling the second rating based on a degree of an importance of the corresponding rule to generate a scaled rating as the rating score for the negative response; and
generating a weighted score for each respective synthetic response of the plurality of synthetic responses based on a weighted combination of all rating scores of the respective synthetic response regarding the plurality of rules.

5. The system of claim 4, wherein the instructions, when executed, further cause the processor to:
generate a paired dataset including a plurality of data pairs, each data pair including: a respective synthetic query of the plurality of synthetic queries, a corresponding positive response and a corresponding negative response; and
train the second model using the paired dataset according to at least one dataset rule, wherein the at least one dataset rule indicates:
a specific type of responses in the paired dataset has a higher weighted score than other responses in the paired dataset,
each response in the paired dataset has a weighted score greater than a threshold, and
one or more quantity criteria for the responses in the paired dataset.

6. The system of claim 5, wherein the instructions, when executed, further cause the processor to:
configure the trained second model based on prompt engineering to generate a configured trained second model, wherein the configured trained second model is capable of addressing a problem of data scarcity by generating a plethora of valid data.

7. The system of claim 6, wherein the training dataset is generated based on:
aggregating the plurality of synthetic responses to generate the paired dataset;
generating the configured trained second model based on the paired dataset and prompt engineering; and
generating the training dataset using the configured trained second model.

8. The system of claim 1, wherein the third model is trained based on a supervised fine tuning on the second model.

9. The system of claim 1, wherein the instructions, when executed, further cause the processor to:
receive, through a user interface, an indication of a user's interaction with a website or software application, the indication including a user query; and
generate, using the trained third model, a response to the user query in real-time.

10. A method, comprising:
generating, using a first model, a plurality of synthetic queries;
generating, using the first model, a plurality of synthetic responses to each of the plurality of synthetic queries, the plurality of synthetic responses being generated based on one or more rules;
aggregating, using a second model, the plurality of synthetic responses to generate a training dataset; and
training a third model using the training dataset, the third model configured to generate responses to user queries in real-time.

11. The method of claim 10, wherein generating the plurality of synthetic queries comprises:
generating query templates for one or more domains associated with information provided to customers interacting with a website of a retailer, the query templates including placeholders related to the retailer;
replacing each placeholder in each of the query templates with a corresponding value to generate a first set of synthetic queries;
generating, based on the first set of synthetic queries, a second set of synthetic queries each directed to a pre-defined concept related to the retailer; and
combining the first set of synthetic queries and the second set of synthetic queries to form the plurality of synthetic queries.

12. The method of claim 10, wherein generating the plurality of synthetic responses to each synthetic query comprises:
generating the plurality of synthetic responses to the synthetic query based on the one or more rules, wherein:
the one or more rules include a plurality of rules,
for each rule of the plurality of rules, the plurality of synthetic responses include:
a positive response having a positive tone and generated based on a positive criteria regarding the rule, and
a negative response having a negative tone and generated based on a negative criteria regarding the rule;
generating a rating score regarding a corresponding rule for each synthetic response of the plurality of synthetic responses, by:
when the synthetic response is a positive response regarding the corresponding rule, generating a first rating as the rating score for the positive response,
when the synthetic response is a negative response regarding the corresponding rule,
generating a second rating different from the first rating,
scaling the second rating based on a degree of an importance of the corresponding rule to generate a scaled rating as the rating score for the negative response; and
generating a weighted score for each respective synthetic response of the plurality of synthetic responses based on a weighted combination of all rating scores of the respective synthetic response regarding the plurality of rules.

13. The method of claim 12, further comprising:
generating a paired dataset including a plurality of data pairs, each data pair including: a respective synthetic query of the plurality of synthetic queries, a corresponding positive response and a corresponding negative response; and
training the second model using the paired dataset according to at least one dataset rule, wherein the at least one dataset rule indicates:
a specific type of responses in the paired dataset has a higher weighted score than other responses in the paired dataset,
each response in the paired dataset has a weighted score greater than a threshold, and
one or more quantity criteria for the responses in the paired dataset.

14. The method of claim 13, further comprising:
configuring the trained second model based on prompt engineering to generate a configured trained second model, wherein the configured trained second model is capable of addressing a problem of data scarcity by generating a plethora of valid data.

15. The method of claim 14, wherein generating the training dataset comprises:
aggregating the plurality of synthetic responses to generate the paired dataset;
generating the configured trained second model based on the paired dataset and prompt engineering; and
generating the training dataset using the configured trained second model.

16. The method of claim 10, wherein the third model is trained based on a supervised fine tuning on the second model.

17. The method of claim 10, further comprising:
receiving, through a user interface, an indication of a user's interaction with a website or software application, the indication including a user query; and
generating, using the trained third model, a response to the user query in real- time.

18. A non-transitory computer readable medium having instructions stored thereon, wherein the instructions, when executed by at least one processor, cause at least one device to perform operations comprising:
generating, using a first model, a plurality of synthetic queries;
generating, using the first model, a plurality of synthetic responses to each of the plurality of synthetic queries, the plurality of synthetic responses being generated based on one or more rules;
aggregating, using a second model, the plurality of synthetic responses to generate a training dataset; and
training a third model using the training dataset, the third model configured to generate responses to user queries in real-time.

19. The non-transitory computer readable medium of claim 18, wherein generating the plurality of synthetic queries comprises:
generating query templates for one or more domains associated with information provided to customers interacting with a website of a retailer, the query templates including placeholders related to the retailer;
replacing each placeholder in each of the query templates with a corresponding value to generate a first set of synthetic queries;
generating, based on the first set of synthetic queries, a second set of synthetic queries each directed to a pre-defined concept related to the retailer; and
combining the first set of synthetic queries and the second set of synthetic queries to form the plurality of synthetic queries.

20. The non-transitory computer readable medium of claim 19, wherein generating the plurality of synthetic responses to each synthetic query comprises:
generating the plurality of synthetic responses to the synthetic query based on the one or more rules, wherein:
the one or more rules include a plurality of rules,
for each rule of the plurality of rules, the plurality of synthetic responses include:
a positive response having a positive tone and generated based on a positive criteria regarding the rule, and
a negative response having a negative tone and generated based on a negative criteria regarding the rule;
generating a rating score regarding a corresponding rule for each synthetic response of the plurality of synthetic responses, by:
when the synthetic response is a positive response regarding the corresponding rule, generating a first rating as the rating score for the positive response,
when the synthetic response is a negative response regarding the corresponding rule,
generating a second rating different from the first rating,
scaling the second rating based on a degree of an importance of the corresponding rule to generate a scaled rating as the rating score for the negative response; and
generating a weighted score for each respective synthetic response of the plurality of synthetic responses based on a weighted combination of all rating scores of the respective synthetic response regarding the plurality of rules.
